(19) United States
(12) Patent Application Publication
(10) Pub. No.: US 2018/0231774 A1
(43) Pub. Date: Aug. 16, 2018

(54) HEAD-UP DISPLAY DEVICE

(71) Applicant: FUJIFILM Corporation, Tokyo (JP)

(72) Inventor: Masanao KAWANA, Saitama (JP)

(73) Assignee: FUJIFILM Corporation, Tokyo (JP)

(21) Appl. No.: 15/895,136

(22) Filed: Feb. 13, 2018

(30) Foreign Application Priority Data
Feb. 16, 2017 (JP) 2017-026715

(51) Int. Cl. G02B 27/01; G02B 17/02; G02B 17/06

(52) U.S. Cl. CPC G02B 27/0101; G02B 27/0149; B60K 37/02; G02B 17/0642; G02B 2027/015; G02B 17/023

(57) ABSTRACT

A head-up display device includes optical path deflecting means, a first mirror having power, a second mirror having power, and a light-blocking member that is provided with an aperture. Display light emitted from an image display surface is reflected by the optical path deflecting means, the first mirror, and the second mirror in this order, passes through the aperture, and reaches an image reflective surface. The image display surface and the optical path deflecting means are disposed on the same side as an observer and on a side opposite to the first mirror with respect to luminous flux that travels toward the aperture from the second mirror, and the image display surface is disposed on a side opposite to the second mirror with respect to luminous flux that travels toward the first mirror from the optical path deflecting means.

### CROSS REFERENCE TO RELATED APPLICATIONS

The present application claims priority under 35 U.S.C. § 119 to Japanese Patent Application No. 2017-026715 filed on Feb. 16, 2017. The above application is hereby expressly incorporated by reference, in its entirety, into the present application.

### BACKGROUND OF THE INVENTION

### 1. Field of the Invention

The present invention relates to a head-up display device that reflects display light of an image, which is displayed on an image display surface, toward an observer by an image reflective surface facing the observer to enlarge and display the image as a virtual image to the observer behind the image reflective surface.

### 2. Description of the Related Art

In the past, a head-up display device has been known as a device that displays information, such as the indication of a direction, calling for attention, and a travel speed, to a driver of an automobile or the like. The head-up display device is to project the virtual image of an image, which is to be displayed, to an image reflective surface, such as a front window or a combiner, so that a driver can recognize information required for the driving of an automobile or the like without taking his eyes off the field of view. JP1993-341226A (JP-H05-341226A) is proposed as such a head-up display device.

### SUMMARY OF THE INVENTION

Since the head-up display device needs to be installed in a limited space around a driver's seat of a moving body, such as an automobile, the head-up display device is required to be small. Further, a virtual image to be displayed on the head-up display device is an image that is obtained in a case in which an image displayed on an image display element, which is provided in the head-up display device, is enlarged and projected to an image reflective surface. The length of an optical path between the image display element and the image reflective surface needs to be lengthened to increase the size of the virtual image for the improvement of visibility.

An increase in the length of the optical path opposes the request for a reduction in the size of the device. However, for the satisfaction of both an increase in the length of the optical path and a reduction in the size of the device, three concave mirrors are combined in the device of JP1993-341226A (JP-H05-341226A) and bend the optical path of display light, which is emitted from the image display element, at three positions. Accordingly, the length of the optical path in a predetermined space is increased. However, since the image display element is disposed below a space, which is partitioned by the three concave mirrors, in a height direction in the device of JP1993-341226A (JP-H05-341226A), it is difficult to reduce the dimension of the device in the height direction. Accordingly, a reduction in the size of the device is restricted.

The invention has been made in consideration of the above-mentioned circumstances, and an object of the invention is to provide a head-up display device that has a small size and high image quality.

A head-up display device of the invention reflects display light of an image, which is displayed on an image display surface, toward an observer by an image reflective surface facing the observer to enlarge and display the image as a virtual image to the observer behind the image reflective surface. The head-up display device includes optical path deflecting means, a first mirror having power, a second mirror having power, and a light-blocking member that is provided with an aperture. Display light emitted from the image display surface is reflected by the optical path deflecting means, the first mirror, and the second mirror in this order, passes through the aperture, and reaches the image reflective surface. The image display surface and the optical path deflecting means are disposed on the same side as the observer and on a side opposite to the first mirror with respect to luminous flux that travels toward the aperture from the second mirror. The image display surface is disposed on a side opposite to the second mirror with respect to luminous flux that travels toward the first mirror from the optical path deflecting means.

Here, the “image display surface” includes not only the image display surface of an image display element but also an image display surface of a diffusion member in a case in which an image displayed on the image display element is temporarily projected to the diffusion member, such as a diffuser, to widen the range of the pupil position of the observer in which a virtual image can be appropriately observed (hereinafter, written as an eye box).

In the head-up display device of the invention, it is preferable that an upper end portion of the light-blocking member, which is closer to the observer than the aperture, is positioned above an upper end of the first mirror in a case in which a direction of an optical path of the display light between the second mirror and the image reflective surface is set to a vertical direction, a side corresponding to the second mirror is set to a lower side, and a side corresponding to the image reflective surface is set to an upper side.

Further, the head-up display device may further include an image display device that includes a light source and an image display element for generating the display light carrying image information by modulating light emitted from the light source, and the light source and the image display element may be disposed between the optical path deflecting means and an upper end portion of the light-blocking member, which is closer to the observer than the aperture, in a vertical direction in a case in which the direction of the optical path of the display light between the second mirror and the image reflective surface is set to the vertical direction, a side corresponding to the second mirror is set to a lower side, and a side corresponding to the image reflective surface is set to an upper side.

In this case, in a case in which the image display device includes a projection optical system that projects an image, which is displayed on the image display element, to the image display surface as an optical intermediate image, it is preferable that the light source, the image display element, and the projection optical system are disposed between the optical path deflecting means and an upper end portion of the light-blocking member, which is closer to the observer than the aperture, in the vertical direction.

Further, the head-up display device may further include an image display device that includes a light source and a light-scanning unit for displaying the image on the image display surface by performing scanning with light emitted from the light source, and the light source and the light-scanning unit may be disposed between the optical path deflecting means and an upper end portion of the light-blocking member, which is closer to the observer than the aperture, in a vertical direction in a case in which the direction of the optical path of the display light between the second mirror and the image reflective surface is set to the vertical direction, a side corresponding to the second mirror is set to a lower side, and a side corresponding to the image reflective surface is set to an upper side.

A head-up display device of the invention reflects display light of an image, which is displayed on an image display surface, toward an observer by an image reflective surface facing the observer to enlarge and display the image as a virtual image to the observer behind the image reflective surface. The head-up display device includes optical path deflecting means, a first mirror having power, a second mirror having power, and a light-blocking member that is provided with an aperture. Display light emitted from the image display surface is reflected by the optical path deflecting means, the first mirror, and the second mirror in this order, passes through the aperture, and reaches the image reflective surface. The image display surface and the optical path deflecting means are disposed on the same side as the observer and on a side opposite to the first mirror with respect to luminous flux that travels toward the aperture from the second mirror. The image display surface is disposed on a side opposite to the second mirror with respect to luminous flux that travels toward the first mirror from the optical path deflecting means. Accordingly, a head-up display device, which has a small size and high image quality, can be obtained.

### BRIEF DESCRIPTION OF THE DRAWINGS

FIG. 1 is a schematic diagram of a driver's seat of an automobile on which a head-up display device according to an embodiment of the invention is mounted.

FIG. 2 is a diagram showing the schematic structure of the head-up display device according to the embodiment of the invention.

FIG. 3 is a diagram showing the schematic structure of a head-up display device according to another aspect of the invention.

FIG. 4 is a diagram showing the schematic structure of a head-up display device according to another aspect of the invention.

FIG. 5 is a diagram showing the schematic structure of a head-up display device according to another aspect of the invention.

FIG. 6 is a diagram showing the structure of an example of the invention.

FIG. 7 is a diagram showing the schematic structure of a head-up display device of Example 1 of the invention.

FIG. 8 is a diagram showing the schematic structure of a head-up display device of Example 2 of the invention.

FIG. 9 is a diagram showing the schematic structure of a head-up display device of Example 3 of the invention.

FIG. 10 is a diagram showing the schematic structure of a head-up display device of Example 4 of the invention.

FIG. 11 is a diagram showing the schematic structure of a head-up display device of Example 5 of the invention.

### DESCRIPTION OF THE PREFERRED EMBODIMENTS

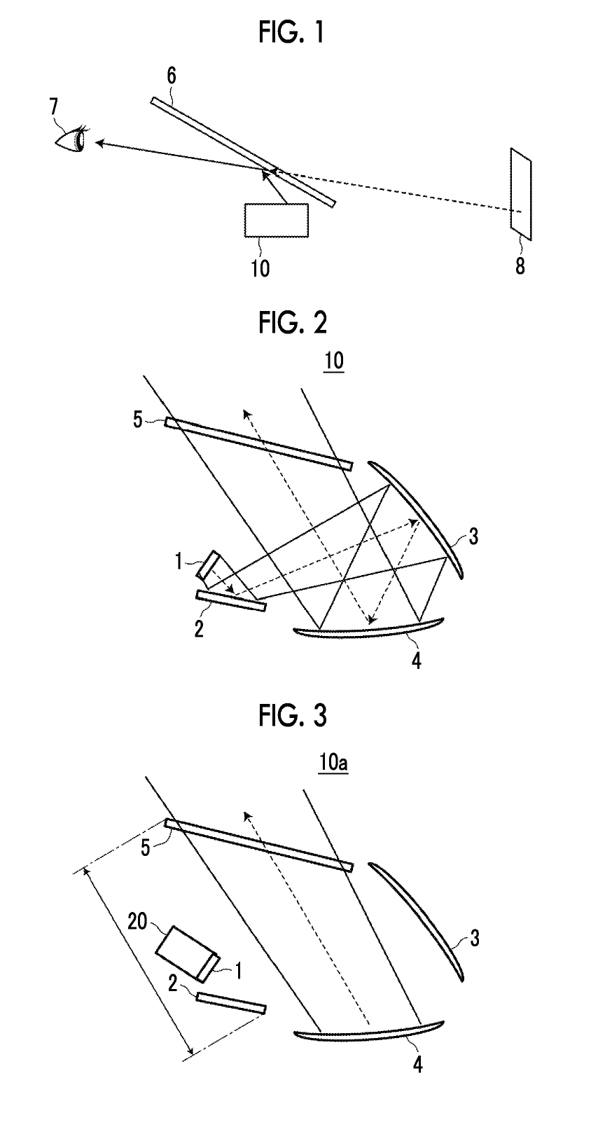

An embodiment of the invention will be described in detail below with reference to drawings. FIG. 1 is a schematic diagram of a driver's seat of an automobile on which a head-up display device according to an embodiment of the invention is mounted, and FIG. 2 is a diagram showing the schematic structure of the head-up display device.

As shown in FIG. 1, a head-up display device 10 of this embodiment is disposed in a dashboard of an automobile, and reflects an image, which is emitted from the inside of the device and represents information, such as travel speed, on a front window (image reflective surface) 6 to enlarge and display the image as a virtual image 8 on the front side of a driver (observer) 7 behind a front window 6.

As shown in FIG. 2, the head-up display device 10 includes optical path deflecting means 2, a first mirror 3 having power, a second mirror 4 having power, and a light-blocking member provided with an aperture 5. The head-up display device 10 is adapted so that display light emitted from an image display surface 1 is reflected by the optical path deflecting means 2, the first mirror 3, and the second mirror 4 in this order, passes through the aperture 5, and reaches the front window (image reflective surface) 6.

Further, the image display surface 1 and the optical path deflecting means 2 are disposed on the same side as the driver (observer) 7 and on the side opposite to the first mirror 3 with respect to luminous flux that travels toward the aperture 5 from the second mirror 4, and the image display surface 1 is disposed on the side opposite to the second mirror 4 with respect to luminous flux that travels toward the first mirror 3 from the optical path deflecting means 2.

In regard to the image display surface 1, the image display surface 1 of FIG. 2 may be formed of the image display surface of an image display element, such as a liquid crystal display (LCD) or an organic light emitting diode (OLED), and a screen may be disposed on the image display surface 1 of FIG. 2 and an image may be projected to the screen by a projector device (not shown).

Further, the optical path deflecting means 2 may have power and may not have power. Furthermore, the optical path deflecting means is not limited to a mirror, and other reflective members, such as a prism, can be used as the optical path deflecting means.

Moreover, the light-blocking member is formed as a housing of the device that covers all of the image display surface 1, the optical path deflecting means 2, the first mirror 3, and the second mirror 4. In FIG. 2, only the position of the aperture 5 is shown and the housing (light-blocking member) is not shown. The housing (light-blocking member) may be composed of a single component, and may be composed of a combination of a plurality of components. For example, in a case in which a shield member for preventing the driver (observer) 7 from being capable of directly visually recognizing the aperture 5 is integrally mounted on the housing, the shield member is also regarded as a part of the housing (light-blocking member).

In a case in which the image display surface 1 is close to the first mirror 3 in this structure, light applied from the outside is likely to be applied to the image display surface 1 and the first mirror 3 requires high power. For this reason, there are problems that the volume of an optical system is increased due to an increase in the curvature of the mirror and image quality deteriorates due to an increase in aberration. In a case in which a distance between the image display surface 1 and the first mirror 3 is increased to avoid the problems, there is a problem that the size of the device is increased.

For this reason, since the optical path deflecting means 2 is disposed between the image display surface 1 and the first mirror 3 to bend an optical path between the image display surface 1 and the first mirror 3 as in the head-up display device 10 of this embodiment, the dimension of a space, which is required for the arrangement of the image display surface 1, the optical path deflecting means 2, and the first mirror 3, in a front-rear direction (a direction orthogonal to the direction of an optical path of display light between the second mirror 4 and the image reflective surface 6 in a case in which the direction of the optical path of display light between the second mirror 4 and the image reflective surface 6 is set to a vertical direction) can be reduced even in a case in which the length of the optical path between the image display surface 1 and the first mirror 3 is made long.

Further, since the image display surface 1 and the optical path deflecting means 2 are disposed on the same side as the driver (observer) 7 and on the side opposite to the first mirror 3 with respect to luminous flux traveling toward the aperture 5 from the second mirror 4 and the image display surface 1 is disposed on the side opposite to the second mirror 4 with respect to luminous flux traveling toward the first mirror 3 from the optical path deflecting means 2, it is difficult for light incident from the aperture 5 to be directly applied to the image display surface 1. Accordingly, it is possible to prevent the deterioration of image quality that is caused by stray light.

Furthermore, since the image display surface 1 is disposed in a space between the optical path deflecting means 2 and the upper surface of the light-blocking member in the vertical direction, the height of the entire head-up display device 10 can be reduced.

According to the above description, the head-up display device 10 of this embodiment can be a head-up display device that has a small size and high image quality.

In a case in which the direction of the optical path of the display light between the second mirror 4 and the front window (image reflective surface) 6 is set to the vertical direction, a side corresponding to the second mirror 4 is set to a lower side, and a side corresponding to the image reflective surface 6 is set to an upper side, it is preferable that an upper end portion of the light-blocking member, which is closer to the observer 7 than the aperture 5, is positioned above the upper end of the first mirror 3 in the head-up display device 10 of this embodiment.

In a case in which this structure is applied, since the apparent size of the aperture 5 viewed from the observer 7 is reduced or the aperture 5 viewed from the observer 7 becomes a blind spot, it is difficult for light reflected from a transparent plate, which is usually provided in the aperture 5, to reach the observer 7. Accordingly, it is possible to prevent the display contrast of the virtual image 8 from being reduced.

Further, as in a head-up display device 10a shown in FIG. 3, an image display device 20, which includes a light source and an image display element for generating the display light carrying image information by modulating light emitted from the light source, may be provided, and the light source and the image display element may be disposed between the optical path deflecting means 2 and the upper end portion of the light-blocking member, which is closer to the observer 7 than the aperture 5, in a vertical direction in a case in which the direction of an optical path of the display light between the second mirror 4 and the image reflective surface 6 is set to the vertical direction, the side corresponding to the second mirror 4 is set to the lower side, and the side corresponding to the image reflective surface 6 is set to the upper side.

Here, the image display device 20 may be adapted so that an image display surface 1 of FIG. 3 is formed of an image display surface of an image display element, such as a liquid crystal display (LCD) or an organic light emitting diode (OLED), and may be adapted so that a screen is disposed on the image display surface 1 and an image is projected to the screen by a projector device (not shown).

In a case in which this structure is applied, it is advantageous to have a reduction in the size of the entire head-up display device 10. Further, since electrical components, such as the light source serving as a heat source and the image display element, are concentrated on the upper portion of the entire head-up display device 10, heat is easily exhausted. Accordingly, it is difficult for a reflective optical system, which is positioned behind the image display surface 1, to be affected by heat.

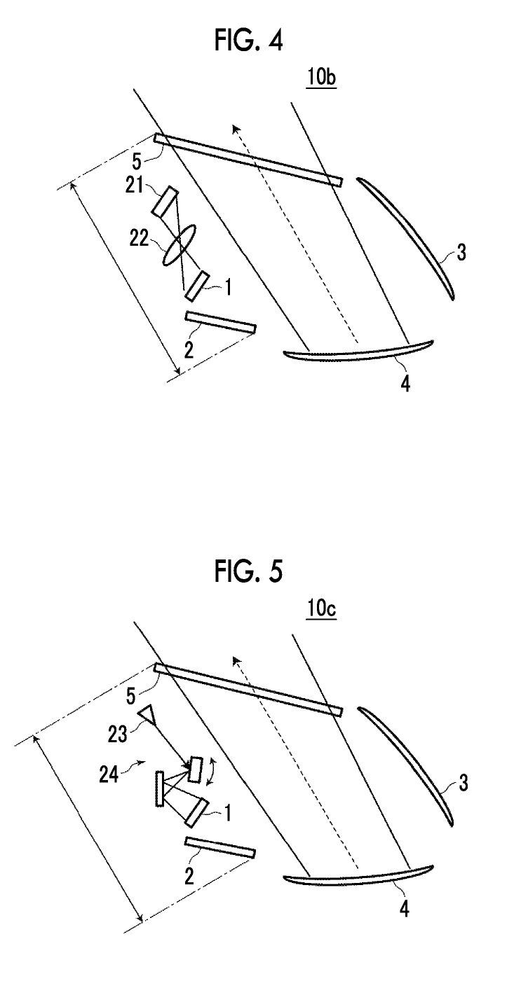

Furthermore, an image displayed on the image display element may be temporarily projected to a diffusion member, such as a diffuser, to widen the range of the pupil position of the observer 7 in which a virtual image can be appropriately observed (eye box). In this case, as in a head-up display device 10b shown in FIG. 4, an image display surface of the diffusion member is disposed at a position overlapping the image display surface 1 of the embodiment, and the image display device may include a projection optical system 22 that projects an image, which is displayed on the image display element 21, to the image display surface 1 as an optical intermediate image.

In this case, it is preferable that all of the light source, the image display element 21, and the projection optical system 22 are disposed between the optical path deflecting means 2 and the upper end portion of the light-blocking member, which is closer to an observer 7 than the aperture 5, in the vertical direction. In a case in which this structure is applied, as described above, it is advantageous to have a reduction in the size of the entire head-up display device 10 and it is difficult for a reflective optical system, which is positioned behind the image display surface 1, to be affected by heat.

Further, as in a head-up display device 10c shown in FIG. 5, an image display device, which includes a light source 23 and a light-scanning unit 24 for displaying an image on the image display surface 1 by performing scanning with light emitted from the light source 23, may be provided, and the light source 23 and the light-scanning unit 24 may be disposed between the optical path deflecting means 2 and the upper end portion of the light-blocking member, which is closer to the observer 7 than the aperture 5, in the vertical direction in a case in which the direction of the optical path of the display light between the second mirror 4 and the image reflective surface 6 is set to the vertical direction, the side corresponding to the second mirror 4 is set to the lower side, and the side corresponding to the image reflective surface 6 is set to the upper side.

Even in a case in which this structure is applied, as described above, it is advantageous to have a reduction in the size of the entire head-up display device 10 and it is difficult for a reflective optical system, which is positioned behind the image display surface 1, to be affected by heat.

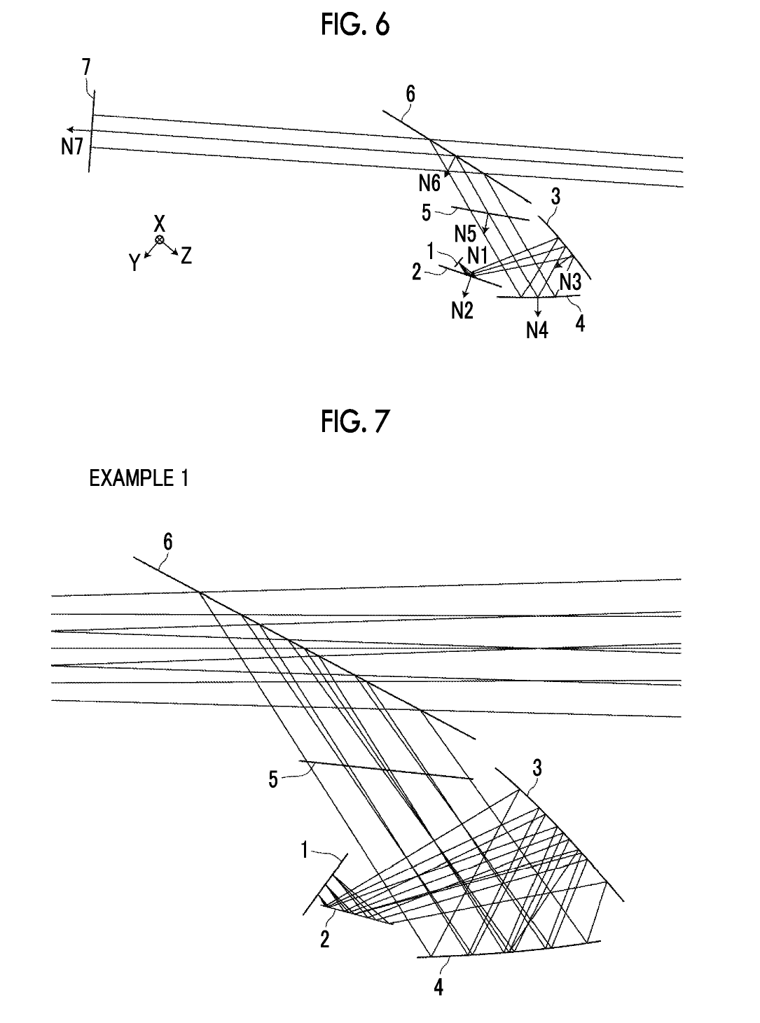

Next, Examples of numerical values of the head-up display device of the invention will be described. First, a head-up display device of Example 1 will be described. FIG. 6 is a diagram showing the structure of Example, and FIG. 7 is a diagram showing the schematic structure of the head-up display device of Example 1.

Table 1 shows data regarding dimensions. Here, Table 1 shows values of FOV (Field Of View) [horizontal direction H×vertical direction V](°), an eye box size (mm×mm), a virtual image distance (mm), and an image display region (mm×mm).

Table 2 shows arrangement coordinate data of the respective elements of the head-up display device. Here, a combination of an absolute coordinate system that has the center of the image display surface 1 shown in FIG. 6 (written in Table 2 as an image display portion) as an origin and local coordinate systems that are set on the surfaces of the respective elements, such as the optical path deflecting means 2, the first mirror 3, the second mirror 4, the aperture 5, the image reflective surface (written in Table 2 as a windshield) 6, the observer 7 (written in Table 2 as a pupil), and the virtual image 8, will be described.

The local coordinate systems will be set as described below. An origin and a Z-axis component vector of each local coordinate system are expressed as (x,y,z) and (i,j,k) in the absolute coordinate system, respectively. Further, a plane (X-Y plane), which passes through the origin of each local coordinate system and is orthogonal to a Z axis, is referred to as a reference plane of each element, and a normal vector N of each reference plane corresponds to the Z axis of the local coordinate system. Furthermore, an X axis is orthogonal to a display plane of FIG. 6 and the back side of the display plane is referred to as a positive side. Moreover, a Y axis and the Z axis are parallel to the display plane of FIG. 6. Further, the Y axis is set so as to correspond to the cross product of the Z axis and the X axis. Furthermore, the reference plane of each of the first mirror 3, the second mirror 4, and the image reflective surface (windshield) 6 has paraxial curvature, and a free-form surface shape is set thereto as an additional shape. Moreover, a rectangular aperture of which a long side corresponds to the X axis and a short side corresponds to the Y axis is set on the reference plane of an element having an aperture value.

Further, the first mirror 3, the second mirror 4, and the image reflective surface (windshield) 6 are reflective surfaces having power, and data regarding free-form surface coefficients of the respective surfaces are shown in Table 3. The free-form surface coefficient is the value of a rotationally asymmetric aspheric surface coefficient C(i,j) of a free-form surface equation expressed as the following equation. A rotationally asymmetric aspheric surface coefficient, which is not particularly written in Table 3, is 0.

$$Z = {\sum }_{i} {\sum }_{j} C ( i , j ) {X}^{i} {Y}^{j}$$

where, X, Y, Z: coordinates using surface vertexes as origins

C(i, j): rotationally asymmetric aspheric surface coefficient (i+j=k, k=1 to 10)

TABLE 1
Example 1

| | |
|---|---|
| FOV[H × V] | 10° × 3.5° |
| EYE BOX SIZE [mm × mm] | 130 × 80 |
| VIRTUAL IMAGE DISTANCE [mm] | 10000 |
| IMAGE DISPLAY REGION [mm × mm] | 78 × 27.3 |

TABLE 2
Example 1

| | COORDINATE | | | NORMAL VECTOR OF | | | APERTURE DATA | | |
|---|---|---|---|---|---|---|---|---|---|
| | OF ORIGIN | | | REFERENCE PLANE | | | APERTURE | APERTURE | APERTURE Y |
| | x | y | z | i | j | k | WIDTH X | WIDTH Y | SHIFT |
| ORIGIN OF | 0.00 | 0.00 | 0.00 | 0.0000 | 0.0000 | 1.0000 | | | |
| ABSOLUTE | | | | | | | | | |
| COORDINATE | | | | | | | | | |
| IMAGE DISPLAY | 0.00 | 0.00 | 0.00 | 0.0000 | −0.1736 | 0.9848 | | | |
| PORTION | | | | | | | | | |
| OPTICAL PATH | 0.00 | 7.81 | 44.32 | 0.0000 | 0.8572 | 0.5150 | | | |
| DEFLECTING | | | | | | | | | |
| MEANS | | | | | | | | | |
| FIRST MIRROR | 0.00 | −193.13 | 201.31 | 0.0000 | 0.9903 | −0.1392 | 400 | 200 | 25 |
| SECOND MIRROR | 0.00 | −58.21 | 206.02 | 0.0000 | 0.6947 | 0.7193 | 400 | 200 | 0 |
| APERTURE | 0.00 | −140.30 | −19.50 | 0.0000 | 0.7661 | 0.6428 | 322 | 192 | −2 |
| WINDSHIELD | 0.00 | −195.02 | −169.86 | 0.0000 | 0.9511 | 0.3090 | | | |
| PUPIL | 0.00 | 333.99 | −897.97 | 0.0000 | 0.7193 | −0.6947 | | | |
| VIRTUAL IMAGE | 0.00 | −5543.86 | 7192.20 | 0.0000 | 0.7193 | −0.6947 | | | |

TABLE 3
Example 1

| PARAXIAL CURVATURE RADIUS | | FIRST MIRROR | SECOND MIRROR | WINDSHIELD |
|---|---|---|---|---|
| C(i, j) | | 1333.2582 | −1569.9551 | ∞ |
| 1 | 0 | 0.0000000000E+00 | 0.0000000000E+00 | 0.0000000000E+00 |
| 0 | 1 | 1.1055227962E−01 | 8.4973753567E−02 | 0.0000000000E+00 |
| 2 | 0 | −6.9486640343E−05 | −1.3391922576E−04 | 0.0000000000E+00 |
| 1 | 1 | 0.0000000000E+00 | 0.0000000000E+00 | 0.0000000000E+00 |
| 0 | 2 | −1.4904054762E−04 | −2.7076002265E−05 | 0.0000000000E+00 |
| 3 | 0 | 0.0000000000E+00 | 0.0000000000E+00 | 0.0000000000E+00 |
| 2 | 1 | 8.0591304076E−07 | 3.8179711806E−07 | 0.0000000000E+00 |
| 1 | 2 | 0.0000000000E+00 | 0.0000000000E+00 | 0.0000000000E+00 |
| 0 | 3 | 9.6212693699E−07 | 4.9104134377E−07 | 0.0000000000E+00 |
| 4 | 0 | 5.0028064912E−10 | 2.5856173209E−10 | 0.0000000000E+00 |
| 3 | 1 | 0.0000000000E+00 | 0.0000000000E+00 | 0.0000000000E+00 |
| 2 | 2 | −6.5403535625E−10 | 1.6042800515E−09 | 0.0000000000E+00 |
| 1 | 3 | 0.0000000000E+00 | 0.0000000000E+00 | 0.0000000000E+00 |
| 0 | 4 | 1.9995969853E−09 | 5.4152826000E−10 | 0.0000000000E+00 |
| 5 | 0 | 0.0000000000E+00 | 0.0000000000E+00 | 0.0000000000E+00 |
| 4 | 1 | 9.6753371634E−12 | 5.4810999778E−12 | 0.0000000000E+00 |
| 3 | 2 | 0.0000000000E+00 | 0.0000000000E+00 | 0.0000000000E+00 |
| 2 | 3 | 7.4465589465E−11 | 8.1361989154E−12 | 0.0000000000E+00 |
| 1 | 4 | 0.0000000000E+00 | 0.0000000000E+00 | 0.0000000000E+00 |
| 0 | 5 | −3.9516603178E−11 | 1.4932141388E−11 | 0.0000000000E+00 |
| 6 | 0 | −7.8628816117E−17 | 4.6396917038E−16 | 0.0000000000E+00 |
| 5 | 1 | 0.0000000000E+00 | 0.0000000000E+00 | 0.0000000000E+00 |
| 4 | 2 | 1.0204981256E−13 | −8.0514923016E−14 | 0.0000000000E+00 |
| 3 | 3 | 0.0000000000E+00 | 0.0000000000E+00 | 0.0000000000E+00 |
| 2 | 4 | −3.7363775596E−13 | −1.5789226039E−13 | 0.0000000000E+00 |
| 1 | 5 | 0.0000000000E+00 | 0.0000000000E+00 | 0.0000000000E+00 |
| 0 | 6 | 1.4127490609E−12 | 2.3035751710E−14 | 0.0000000000E+00 |
| 7 | 0 | 0.0000000000E+00 | 0.0000000000E+00 | 0.0000000000E+00 |
| 6 | 1 | −6.2262681349E−16 | −2.0293373941E−16 | 0.0000000000E+00 |
| 5 | 2 | 0.0000000000E+00 | 0.0000000000E+00 | 0.0000000000E+00 |
| 3 | 4 | −1.6698329404E−15 | 6.5127710632E−17 | 0.0000000000E+00 |
| 4 | 3 | 0.0000000000E+00 | 0.0000000000E+00 | 0.0000000000E+00 |
| 2 | 5 | −3.8934503143E−15 | 1.4237933723E−16 | 0.0000000000E+00 |
| 1 | 6 | 0.0000000000E+00 | 0.0000000000E+00 | 0.0000000000E+00 |
| 0 | 7 | −9.6847782819E−15 | −1.8610632440E−15 | 0.0000000000E+00 |
| 8 | 0 | 2.6273767600E−19 | 5.7143375954E−21 | 0.0000000000E+00 |
| 7 | 1 | 0.0000000000E+00 | 0.0000000000E+00 | 0.0000000000E+00 |
| 6 | 2 | −2.5278124558E−18 | 3.6579653545E−18 | 0.0000000000E+00 |
| 5 | 3 | 0.0000000000E+00 | 0.0000000000E+00 | 0.0000000000E+00 |
| 4 | 4 | 2.2879603267E−17 | 7.7469990124E−18 | 0.0000000000E+00 |
| 3 | 5 | 0.0000000000E+00 | 0.0000000000E+00 | 0.0000000000E+00 |
| 2 | 6 | 3.5482113810E−18 | −8.6142994198E−18 | 0.0000000000E+00 |
| 1 | 7 | 0.0000000000E+00 | 0.0000000000E+00 | 0.0000000000E+00 |
| 0 | 8 | 1.5447891319E−17 | −1.1545361883E−18 | 0.0000000000E+00 |
| 9 | 0 | 0.0000000000E+00 | 0.0000000000E+00 | 0.0000000000E+00 |
| 8 | 1 | 1.3720886723E−20 | 3.4698015133E−21 | 0.0000000000E+00 |
| 7 | 2 | 0.0000000000E+00 | 0.0000000000E+00 | 0.0000000000E+00 |
| 6 | 3 | 1.7662834882E−20 | 1.0411466373E−21 | 0.0000000000E+00 |
| 5 | 4 | 0.0000000000E+00 | 0.0000000000E+00 | 0.0000000000E+00 |
| 4 | 5 | 5.8801285152E−20 | −2.8725732154E−20 | 0.0000000000E+00 |
| 3 | 6 | 0.0000000000E+00 | 0.0000000000E+00 | 0.0000000000E+00 |
| 2 | 7 | 4.6678233469E−19 | 3.1841871704E−20 | 0.0000000000E+00 |
| 1 | 8 | 0.0000000000E+00 | 0.0000000000E+00 | 0.0000000000E+00 |
| 0 | 9 | −6.2283590998E−19 | 3.8150969673E−20 | 0.0000000000E+00 |
| 10 | 0 | −5.1211015791E−24 | 1.6058531486E−24 | 0.0000000000E+00 |
| 9 | 1 | 0.0000000000E+00 | 0.0000000000E+00 | 0.0000000000E+00 |
| 8 | 2 | 8.2165172671E−23 | −4.0173217365E−23 | 0.0000000000E+00 |
| 7 | 3 | 0.0000000000E+00 | 0.0000000000E+00 | 0.0000000000E+00 |
| 6 | 4 | −3.8498222727E−22 | −1.6046071546E−22 | 0.0000000000E+00 |
| 5 | 5 | 0.0000000000E+00 | 0.0000000000E+00 | 0.0000000000E+00 |
| 4 | 6 | −4.6505938543E−22 | 1.6561734319E−22 | 0.0000000000E+00 |
| 3 | 7 | 0.0000000000E+00 | 0.0000000000E+00 | 0.0000000000E+00 |
| 2 | 8 | −3.2672438268E−21 | 5.6179564462E−23 | 0.0000000000E+00 |
| 1 | 9 | 0.0000000000E+00 | 0.0000000000E+00 | 0.0000000000E+00 |
| 0 | 10 | 5.6751731653E−21 | 8.9247354367E−22 | 0.0000000000E+00 |

Since signs, meanings, and description methods of the respective data mentioned in the description of Example 1 are the same as those in the following examples as long as the signs, meanings, and description methods of the respective data mentioned in the description of Example 1 are not particularly refused, the repeated description thereof will be omitted below.

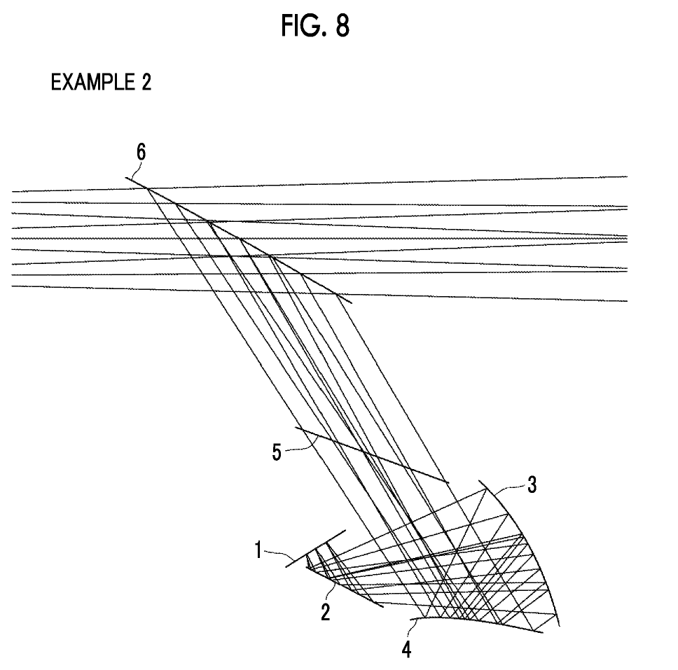

Next, a head-up display device of Example 2 will be described. FIG. 8 is a diagram showing the schematic structure of the head-up display device of Example 2. Further, Table 4 shows data regarding dimensions of the head-up display device of Example 2, Table 5 shows arrangement coordinate data of the respective elements, and Table 6 shows data regarding free-form surface coefficients of the respective mirrors.

TABLE 4
Example 2

| | |
|---|---|
| FOV[H × V] | 10° × 3.5° |
| EYE BOX SIZE [mm × mm] | 130 × 120 |
| VIRTUAL IMAGE DISTANCE [mm] | 10000 |
| IMAGE DISPLAY REGION [mm × mm] | 100 × 35 |

TABLE 5
Example 2

| | COORDINATE | | | NORMAL VECTOR OF | | | APERTURE DATA | | |
|---|---|---|---|---|---|---|---|---|---|
| | OF ORIGIN | | | REFERENCE PLANE | | | APERTURE | APERTURE | APERTURE Y |
| | x | y | z | i | j | k | WIDTH X | WIDTH Y | SHIFT |
| ORIGIN OF | 0.00 | 0.00 | 0.00 | 0.0000 | 0.0000 | 1.0000 | | | |
| ABSOLUTE | | | | | | | | | |
| COORDINATE | | | | | | | | | |
| IMAGE DISPLAY | 0.00 | 0.00 | 0.00 | 0.0000 | −0.1736 | 0.9848 | | | |
| PORTION | | | | | | | | | |
| OPTICAL PATH | 0.00 | 8.68 | 49.24 | 0.0000 | 0.7661 | 0.6428 | | | |
| DEFLECTING | | | | | | | | | |
| MEANS | | | | | | | | | |
| FIRST MIRROR | 0.00 | −282.62 | 155.27 | 0.0000 | 0.9848 | 0.1736 | 388 | 258 | −18.5 |
| SECOND MIRROR | 0.00 | −130.39 | 210.67 | 0.0000 | 0.4384 | 0.8988 | 382 | 206 | −27 |
| APERTURE | 0.00 | −140.86 | −89.14 | 0.0000 | 0.6692 | 0.7432 | 342 | 252 | −12.5 |
| WINDSHIELD | 0.00 | −154.12 | −468.91 | 0.0000 | 0.7880 | 0.6157 | | | |
| PUPIL | 0.00 | 609.12 | −945.84 | 0.0000 | 0.9271 | −0.3746 | | | |
| VIRTUAL IMAGE | 0.00 | −7871.36 | 4353.35 | 0.0000 | 0.9271 | −0.3746 | | | |

TABLE 6
Example 2

| PARAXIAL CURVATURE RADIUS | | FIRST MIRROR | SECOND MIRROR | WINDSHIELD |
|---|---|---|---|---|
| C(i, j) | | 638.8722 | 969.3421 | ∞ |
| 1 | 0 | 0.0000000000E+00 | 0.0000000000E+00 | 0.0000000000E+00 |
| 0 | 1 | −2.5232895177E−02 | −1.6735086113E−02 | 9.5121514901E−03 |
| 2 | 0 | −2.4273405476E−04 | −5.8888647409E−04 | 1.1726714047E−04 |
| 1 | 1 | 0.0000000000E+00 | 0.0000000000E+00 | 0.0000000000E+00 |
| 0 | 2 | 3.3989983887E−04 | 3.2341887877E−04 | 6.6451462078E−05 |
| 3 | 0 | 0.0000000000E+00 | 0.0000000000E+00 | 0.0000000000E+00 |
| 2 | 1 | 2.8139191334E−07 | −3.4422120635E−07 | −4.0984711760E−08 |
| 1 | 2 | 0.0000000000E+00 | 0.0000000000E+00 | 0.0000000000E+00 |
| 0 | 3 | 6.5832123054E−07 | 2.4784486369E−06 | 5.8352454395E−08 |
| 4 | 0 | 5.5050433218E−10 | 1.2160955525E−09 | 1.8076488220E−10 |
| 3 | 1 | 0.0000000000E+00 | 0.0000000000E+00 | 0.0000000000E+00 |
| 2 | 2 | 2.4422971705E−09 | 9.5273858773E−10 | −8.5663602372E−11 |
| 1 | 3 | 0.0000000000E+00 | 0.0000000000E+00 | 0.0000000000E+00 |
| 0 | 4 | 4.9958283580E−09 | 3.6893108694E−08 | 5.1841972882E−11 |
| 5 | 0 | 0.0000000000E+00 | 0.0000000000E+00 | 0.0000000000E+00 |
| 4 | 1 | −1.2272727738E−11 | −1.5457297953E−11 | 1.6953219966E−13 |
| 3 | 2 | 0.0000000000E+00 | 0.0000000000E+00 | 0.0000000000E+00 |
| 2 | 3 | −6.1069075083E−12 | −5.7630276438E−11 | 9.4181254950E−14 |
| 1 | 4 | 0.0000000000E+00 | 0.0000000000E+00 | 0.0000000000E+00 |
| 0 | 5 | −1.6174593041E−11 | 3.6968109431E−10 | 4.3631225108E−14 |
| 6 | 0 | −3.7323114616E−14 | −5.3007444907E−14 | −5.7915957618E−15 |
| 5 | 1 | 0.0000000000E+00 | 0.0000000000E+00 | 0.0000000000E+00 |
| 4 | 2 | −4.4169412115E−14 | −1.6931875350E−14 | 1.2160292018E−15 |
| 3 | 3 | 0.0000000000E+00 | 0.0000000000E+00 | 0.0000000000E+00 |
| 2 | 4 | −7.5882459979E−14 | −9.0572799152E−13 | 3.9230162978E−16 |
| 1 | 5 | 0.0000000000E+00 | 0.0000000000E+00 | 0.0000000000E+00 |
| 0 | 6 | 3.2765918717E−14 | 9.9594464171E−13 | 2.0358629739E−16 |
| 7 | 0 | 0.0000000000E+00 | 0.0000000000E+00 | 0.0000000000E+00 |
| 6 | 1 | 2.5980257478E−16 | 2.3521285479E−16 | −2.9914127753E−18 |
| 5 | 2 | 0.0000000000E+00 | 0.0000000000E+00 | 0.0000000000E+00 |
| 3 | 4 | 1.8870262239E−16 | 1.1240976285E−15 | −7.1848493425E−18 |
| 4 | 3 | 0.0000000000E+00 | 0.0000000000E+00 | 0.0000000000E+00 |
| 2 | 5 | −7.3866440760E−17 | −2.7049997641E−15 | 5.6825058659E−20 |
| 1 | 6 | 0.0000000000E+00 | 0.0000000000E+00 | 0.0000000000E+00 |
| 0 | 7 | 3.0545497522E−15 | −3.6018154166E−16 | 5.7818036623E−19 |
| 8 | 0 | 1.5019831494E−18 | 2.1571461216E−18 | 1.4548651606E−19 |
| 7 | 1 | 0.0000000000E+00 | 0.0000000000E+00 | 0.0000000000E+00 |
| 6 | 2 | 6.6546214979E−20 | −1.6882911047E−18 | −4.0929595963E−20 |
| 5 | 3 | 0.0000000000E+00 | 0.0000000000E+00 | 0.0000000000E+00 |
| 4 | 4 | 8.7958863303E−18 | 2.7392981239E−17 | −1.2197758235E−20 |
| 3 | 5 | 0.0000000000E+00 | 0.0000000000E+00 | 0.0000000000E+00 |
| 2 | 6 | −6.6558870525E−18 | −5.2296885526E−18 | −5.1769216490E−21 |
| 1 | 7 | 0.0000000000E+00 | 0.0000000000E+00 | 0.0000000000E+00 |
| 0 | 8 | −3.9827606742E−18 | 2.7490880312E−17 | −6.4366746130E−21 |
| 9 | 0 | 0.0000000000E+00 | 0.0000000000E+00 | 0.0000000000E+00 |
| 8 | 1 | −1.3744345677E−21 | −6.1828087383E−22 | 2.2144541119E−23 |
| 7 | 2 | 0.0000000000E+00 | 0.0000000000E+00 | 0.0000000000E+00 |
| 6 | 3 | −8.0602311361E−21 | −2.2072580654E−20 | 1.4456081800E−22 |
| 5 | 4 | 0.0000000000E+00 | 0.0000000000E+00 | 0.0000000000E+00 |
| 4 | 5 | 2.0929383613E−20 | 1.0835557951E−19 | 1.2455653871E−23 |
| 3 | 6 | 0.0000000000E+00 | 0.0000000000E+00 | 0.0000000000E+00 |
| 2 | 7 | −4.4562334461E−20 | −6.2908798651E−19 | −6.9948609813E−24 |
| 1 | 8 | 0.0000000000E+00 | 0.0000000000E+00 | 0.0000000000E+00 |
| 0 | 9 | −1.2887912561E−19 | 3.0690841890E−19 | −7.3001740686E−24 |
| 10 | 0 | −2.2985663059E−23 | −3.2949005086E−23 | −1.3871955134E−24 |
| 9 | 1 | 0.0000000000E+00 | 0.0000000000E+00 | 0.0000000000E+00 |
| 8 | 2 | 2.6749827489E−23 | 8.8326170412E−23 | 5.3699663027E−25 |
| 7 | 3 | 0.0000000000E+00 | 0.0000000000E+00 | 0.0000000000E+00 |
| 6 | 4 | −1.3713070872E−22 | −6.7795546201E−22 | 2.5361779086E−25 |
| 5 | 5 | 0.0000000000E+00 | 0.0000000000E+00 | 0.0000000000E+00 |
| 4 | 6 | −2.2119871567E−22 | 7.8769200625E−22 | 5.3614470963E−26 |
| 3 | 7 | 0.0000000000E+00 | 0.0000000000E+00 | 0.0000000000E+00 |
| 2 | 8 | 8.1672249007E−22 | −2.8099920766E−21 | 8.4180607892E−26 |
| 1 | 9 | 0.0000000000E+00 | 0.0000000000E+00 | 0.0000000000E+00 |
| 0 | 10 | −4.1524642777E−22 | 7.6964306156E−22 | 8.2400402372E−26 |

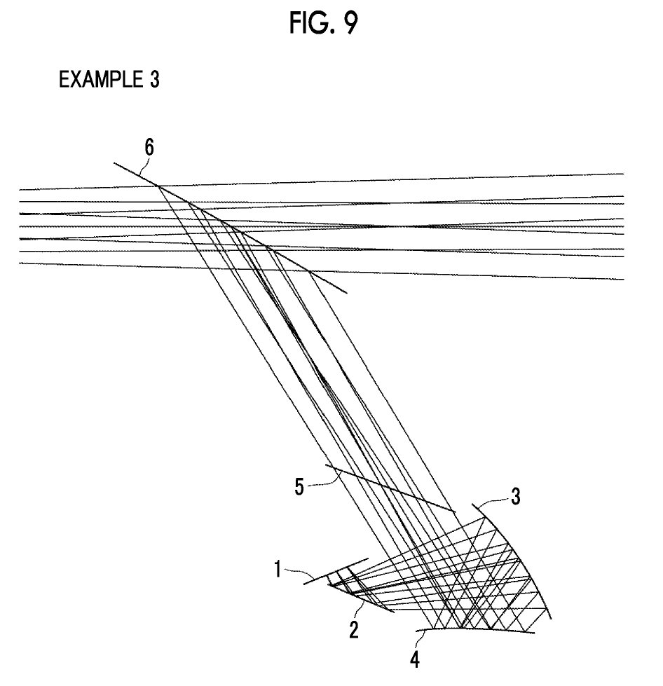

Next, a head-up display device of Example 3 will be described. FIG. 9 is a diagram showing the schematic structure of the head-up display device of Example 3. Further, Table 7 shows data regarding dimensions of the head-up display device of Example 3, Table 8 shows arrangement coordinate data of the respective elements, and Table 9 shows data regarding free-form surface coefficients of the respective mirrors.

TABLE 7
Example 3

| | |
|---|---|
| FOV[H × V] | 10° × 3.5° |
| EYE BOX SIZE [mm × mm] | 130 × 80 |
| VIRTUAL IMAGE DISTANCE [mm] | 10000 |
| IMAGE DISPLAY REGION [mm × mm] | 93 × 32.55 |

TABLE 8
Example 3

| | COORDINATE | | | NORMAL VECTOR OF | | | APERTURE DATA | | |
|---|---|---|---|---|---|---|---|---|---|
| | OF ORIGIN | | | REFERENCE PLANE | | | APERTURE | APERTURE | APERTURE Y |
| | x | y | z | i | j | k | WIDTH X | WIDTH Y | SHIFT |
| ORIGIN OF | 0.00 | 0.00 | 0.00 | 0.0000 | 0.0000 | 1.0000 | | | |
| ABSOLUTE | | | | | | | | | |
| COORDINATE | | | | | | | | | |
| IMAGE DISPLAY | 0.00 | 0.00 | 0.00 | 0.0000 | 0.1736 | 0.9848 | | | |
| PORTION | | | | | | | | | |
| OPTICAL PATH | 0.00 | −6.95 | 39.39 | 0.0000 | 0.8191 | 0.5736 | | | |
| DEFLECTING | | | | | | | | | |
| MEANS | | | | | | | | | |
| FIRST MIRROR | 0.00 | −263.00 | 84.54 | 0.0000 | 1.0000 | 0.0000 | 380 | 210 | 1 |
| SECOND MIRROR | 0.00 | −146.08 | 152.04 | 0.0000 | 0.5878 | 0.8091 | 380 | 178 | −17.5 |
| APERTURE | 0.00 | −111.29 | −95.53 | 0.0000 | 0.7880 | 0.6157 | 342 | 208 | −15.5 |
| WINDSHIELD | 0.00 | −48.66 | −541.15 | 0.0000 | 0.8829 | 0.4696 | | | |
| PUPIL | 0.00 | 785.80 | −878.29 | 0.0000 | 0.8481 | −0.5299 | | | |
| VIRTUAL IMAGE | 0.00 | −8486.03 | 2867.77 | 0.0000 | 0.8481 | −0.5299 | | | |

TABLE 9
Example 3

| PARAXIAL CURVATURE RADIUS | | FIRST MIRROR | SECOND MIRROR | WINDSHIELD |
|---|---|---|---|---|
| C(i, j) | | 619.2304 | −2425.0992 | ∞ |
| 1 | 0 | 0.0000000000E+00 | 0.0000000000E+00 | 0.0000000000E+00 |
| 0 | 1 | 3.2850743311E−02 | 5.6148579595E−02 | 9.5121514901E−03 |
| 2 | 0 | −3.8277179394E−04 | −9.7064115742E−05 | 1.1726714047E−04 |
| 1 | 1 | 0.0000000000E+00 | 0.0000000000E+00 | 0.0000000000E+00 |
| 0 | 2 | 2.0036343575E−04 | 7.2848909964E−04 | 6.6451462078E−05 |
| 3 | 0 | 0.0000000000E+00 | 0.0000000000E+00 | 0.0000000000E+00 |
| 2 | 1 | −5.4913793564E−07 | −7.4532765343E−07 | −4.0984711760E−08 |
| 1 | 2 | 0.0000000000E+00 | 0.0000000000E+00 | 0.0000000000E+00 |
| 0 | 3 | 7.9922824997E−09 | 7.3458092834E−07 | 5.8352454395E−08 |
| 4 | 0 | 3.7975732067E−09 | 3.4248381282E−09 | 1.8076488220E−10 |
| 3 | 1 | 0.0000000000E+00 | 0.0000000000E+00 | 0.0000000000E+00 |
| 2 | 2 | 6.1519051420E−09 | 7.9951006742E−09 | −8.5663602372E−11 |
| 1 | 3 | 0.0000000000E+00 | 0.0000000000E+00 | 0.0000000000E+00 |
| 0 | 4 | 1.0230307393E−08 | 2.7278143377E−08 | 5.1841972882E−11 |
| 5 | 0 | 0.0000000000E+00 | 0.0000000000E+00 | 0.0000000000E+00 |
| 4 | 1 | 2.5901290821E−11 | −9.7155496759E−12 | 1.6953219966E−13 |
| 3 | 2 | 0.0000000000E+00 | 0.0000000000E+00 | 0.0000000000E+00 |
| 2 | 3 | −2.9186240177E−11 | −3.7329469641E−12 | 9.4181254950E−14 |
| 1 | 4 | 0.0000000000E+00 | 0.0000000000E+00 | 0.0000000000E+00 |
| 0 | 5 | 1.5909219193E−10 | 4.7394422395E−10 | 4.3631225108E−14 |
| 6 | 0 | −1.2578494427E−13 | −7.7494521997E−14 | −5.7915957618E−15 |
| 5 | 1 | 0.0000000000E+00 | 0.0000000000E+00 | 0.0000000000E+00 |
| 4 | 2 | −4.3525963668E−13 | −6.3537273965E−13 | 1.2160292018E−15 |
| 3 | 3 | 0.0000000000E+00 | 0.0000000000E+00 | 0.0000000000E+00 |
| 2 | 4 | 5.8950435706E−13 | 4.6640735878E−13 | 3.9230162978E−16 |
| 1 | 5 | 0.0000000000E+00 | 0.0000000000E+00 | 0.0000000000E+00 |
| 0 | 6 | −2.1364747760E−12 | 2.6629041236E−12 | 2.0358629739E−16 |
| 7 | 0 | 0.0000000000E+00 | 0.0000000000E+00 | 0.0000000000E+00 |
| 6 | 1 | −1.4718025123E−15 | 3.6069585730E−16 | −2.9914127753E−18 |
| 5 | 2 | 0.0000000000E+00 | 0.0000000000E+00 | 0.0000000000E+00 |
| 3 | 4 | 2.2028323980E−15 | −8.0281252423E−16 | −7.1848493425E−18 |
| 4 | 3 | 0.0000000000E+00 | 0.0000000000E+00 | 0.0000000000E+00 |
| 2 | 5 | −3.5847943549E−15 | −2.2859621276E−14 | 5.6825058659E−20 |
| 1 | 6 | 0.0000000000E+00 | 0.0000000000E+00 | 0.0000000000E+00 |
| 0 | 7 | −4.5405662705E−15 | 2.2492915194E−14 | 5.7818036623E−19 |
| 8 | 0 | 3.6398537733E−20 | −6.1523356070E−19 | 1.4548651606E−19 |
| 7 | 1 | 0.0000000000E+00 | 0.0000000000E+00 | 0.0000000000E+00 |
| 6 | 2 | 2.1907843571E−17 | 3.1346118392E−17 | −4.0929595963E−20 |
| 5 | 3 | 0.0000000000E−00 | 0.0000000000E+00 | 0.0000000000E+00 |
| 4 | 4 | −2.5436675449E−17 | −5.4000304856E−17 | −1.2197758235E−20 |
| 3 | 5 | 0.0000000000E+00 | 0.0000000000E+00 | 0.0000000000E+00 |
| 2 | 6 | −4.6997752992E−17 | −2.6824098943E−16 | −5.1769216490E−21 |
| 1 | 7 | 0.0000000000E+00 | 0.0000000000E+00 | 0.0000000000E+00 |
| 0 | 8 | 2.9383710457E−16 | 1.8165136670E−16 | −6.4366746130E−21 |
| 9 | 0 | 0.0000000000E+00 | 0.0000000000E+00 | 0.0000000000E+00 |
| 8 | 1 | 3.1381302742E−20 | −3.9496006148E−21 | 2.2144541119E−23 |
| 7 | 2 | 0.0000000000E+00 | 0.0000000000E+00 | 0.0000000000E+00 |
| 6 | 3 | −5.0794788864E−20 | 1.1546437059E−20 | 1.4456081800E−22 |
| 5 | 4 | 0.0000000000E+00 | 0.0000000000E+00 | 0.0000000000E+00 |
| 4 | 5 | 3.0356555616E−20 | 1.7732433652E−19 | 1.2455653871E−23 |
| 3 | 6 | 0.0000000000E−00 | 0.0000000000E+00 | 0.0000000000E+00 |
| 2 | 7 | −7.0524012719E−20 | 1.6237844407E−18 | −6.9948609813E−24 |
| 1 | 8 | 0.0000000000E+00 | 0.0000000000E+00 | 0.0000000000E+00 |
| 0 | 9 | −4.4840435358E−19 | −5.2319185821E−19 | −7.3001740686E−24 |
| 10 | 0 | 4.7752008418E−23 | 3.8096448835E−23 | −1.3871955134E−24 |
| 9 | 1 | 0.0000000000E+00 | 0.0000000000E+00 | 0.0000000000E+00 |
| 8 | 2 | −3.2530321489E−22 | −4.8463738129E−22 | 5.3699663027E−25 |
| 7 | 3 | 0.0000000000E+00 | 0.0000000000E+00 | 0.0000000000E+00 |
| 6 | 4 | 3.1910807498E−22 | 7.9585965803E−22 | 2.5361779086E−25 |
| 5 | 5 | 0.0000000000E+00 | 0.0000000000E+00 | 0.0000000000E+00 |
| 4 | 6 | 6.9273775357E−22 | 4.0614001347E−21 | 5.3614470963E−26 |
| 3 | 7 | 0.0000000000E+00 | 0.0000000000E+00 | 0.0000000000E+00 |
| 2 | 8 | 4.4929425029E−21 | 2.8054241189E−20 | 8.4180607892E−26 |
| 1 | 9 | 0.0000000000E+00 | 0.0000000000E+00 | 0.0000000000E+00 |
| 0 | 10 | −1.0931184482E−20 | −3.3528179194E−21 | 8.2400402372E−26 |

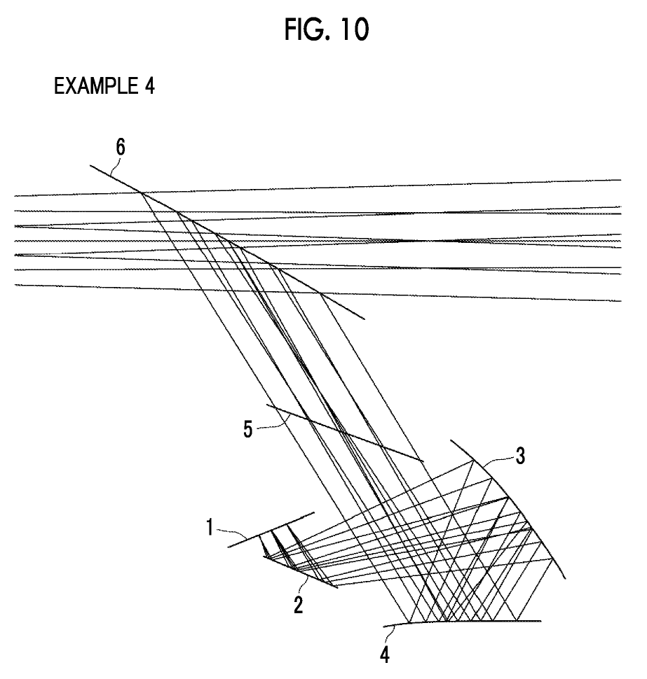

Next, a head-up display device of Example 4 will be described. FIG. 10 is a diagram showing the schematic structure of the head-up display device of Example 4. Further, Table 10 shows data regarding dimensions of the head-up display device of Example 4, Table 11 shows arrangement coordinate data of the respective elements, and Table 12 shows data regarding free-form surface coefficients of the respective mirrors.

TABLE 10
Example 4

| | |
|---|---|
| FOV[H × V] | 10° × 3.5° |
| EYE BOX SIZE [mm × mm] | 130 × 80 |
| VIRTUAL IMAGE DISTANCE [mm] | 10000 |
| IMAGE DISPLAY REGION [mm × mm] | 103 × 36.05 |

TABLE 11
Example 4

| | COORDINATE | | | NORMAL VECTOR OF | | | APERTURE DATA | | |
|---|---|---|---|---|---|---|---|---|---|
| | OF ORIGIN | | | REFERENCE PLANE | | | APERTURE | APERTURE | APERTURE Y |
| | x | y | z | i | j | k | WIDTH X | WIDTH Y | SHIFT |
| ORIGIN OF | 0.00 | 0.00 | 0.00 | 0.0000 | 0.0000 | 1.0000 | | | |
| ABSOLUTE | | | | | | | | | |
| COORDINATE | | | | | | | | | |
| IMAGE DISPLAY | 0.00 | 0.00 | 0.00 | 0.0000 | 0.1736 | 0.9848 | | | |
| PORTION | | | | | | | | | |
| OPTICAL PATH | 0.00 | −10.42 | 59.09 | 0.0000 | 0.8191 | 0.5736 | | | |
| DEFLECTING | | | | | | | | | |
| MEANS | | | | | | | | | |
| FIRST MIRROR | 0.00 | −305.86 | 111.18 | 0.0000 | 1.0000 | 0.0000 | 358 | 226 | 25 |
| SECOND MIRROR | 0.00 | −165.57 | 192.18 | 0.0000 | 0.5878 | 0.8091 | 368 | 198 | −17.5 |
| APERTURE | 0.00 | −126.60 | −85.09 | 0.0000 | 0.7880 | 0.6157 | 326 | 212 | −9.5 |
| WINDSHIELD | 0.00 | −87.63 | −362.37 | 0.0000 | 0.8829 | 0.4696 | | | |
| PUPIL | 0.00 | 746.84 | −699.51 | 0.0000 | 0.8481 | −0.5299 | | | |
| VIRTUAL IMAGE | 0.00 | −8525.00 | 3046.55 | 0.0000 | 0.8481 | −0.5299 | | | |

TABLE 12
Example 4

| PARAXIAL CURVATURE RADIUS | | FIRST MIRROR | SECOND MIRROR | WINDSHIELD |
|---|---|---|---|---|
| C(i, j) | | 1026.651 | 4761.9555 | ∞ |
| 1 | 0 | 0.0000000000E+00 | 0.0000000000E+00 | 0.0000000000E+00 |
| 0 | 1 | 7.3220964076E−02 | 8.9390516516E−02 | 9.5121514901E−03 |
| 2 | 0 | −8.3477206640E−05 | −3.0007327961E−04 | 1.1726714047E−04 |
| 1 | 1 | 0.0000000000E+00 | 0.0000000000E+00 | 0.0000000000E+00 |
| 0 | 2 | 8.0681102018E−05 | 2.4367452272E−04 | 6.6451462078E−05 |
| 3 | 0 | 0.0000000000E+00 | 0.0000000000E+00 | 0.0000000000E+00 |
| 2 | 1 | 2.1796127494E−07 | −3.2873648872E−07 | −4.0984711760E−08 |
| 1 | 2 | 0.0000000000E+00 | 0.0000000000E+00 | 0.0000000000E+00 |
| 0 | 3 | 2.2092923530E−06 | 3.2116002837E−06 | 5.8352454395E−08 |
| 4 | 0 | 5.5805809196E−10 | 4.5231467688E−10 | 1.8076488220E−10 |
| 3 | 1 | 0.0000000000E+00 | 0.0000000000E+00 | 0.0000000000E+00 |
| 2 | 2 | −2.8810982374E−09 | −9.3945543657E−10 | −8.5663602372E−11 |
| 1 | 3 | 0.0000000000E+00 | 0.0000000000E+00 | 0.0000000000E+00 |
| 0 | 4 | 2.2253952331E−09 | 1.8174171055E−08 | 5.1841972882E−11 |
| 5 | 0 | 0.0000000000E+00 | 0.0000000000E+00 | 0.0000000000E+00 |
| 4 | 1 | 3.3030653699E−12 | 3.5329380955E−13 | 1.6953219966E−13 |
| 3 | 2 | 0.0000000000E+00 | 0.0000000000E+00 | 0.0000000000E+00 |
| 2 | 3 | 6.7355211567E−11 | 2.3792383056E−11 | 9.4181254950E−14 |
| 1 | 4 | 0.0000000000E+00 | 0.0000000000E+00 | 0.0000000000E+00 |
| 0 | 5 | −1.9379280978E−11 | 1.2784389596E−10 | 4.3631225108E−14 |
| 6 | 0 | 1.7946121415E−15 | 3.6414221931E−15 | −5.7915957618E−15 |
| 5 | 1 | 0.0000000000E+00 | 0.0000000000E+00 | 0.0000000000E+00 |
| 4 | 2 | −2.0871610587E−14 | −7.9575619615E−14 | 1.2160292018E−15 |
| 3 | 3 | 0.0000000000E+00 | 0.0000000000E+00 | 0.0000000000E+00 |
| 2 | 4 | −2.4280169933E−13 | −1.9353600705E−13 | 3.9230162978E−16 |
| 1 | 5 | 0.0000000000E+00 | 0.0000000000E+00 | 0.0000000000E+00 |
| 0 | 6 | 5.3202342315E−13 | 2.5510173083E−13 | 2.0358629739E−16 |
| 7 | 0 | 0.0000000000E+00 | 0.0000000000E+00 | 0.0000000000E+00 |
| 6 | 1 | −1.1141973117E−16 | −7.8028019609E−17 | −2.9914127753E−18 |
| 5 | 2 | 0.0000000000E+00 | 0.0000000000E+00 | 0.0000000000E+00 |
| 3 | 4 | −3.0085791740E−16 | 3.1872418620E−16 | −7.1848493425E−18 |
| 4 | 3 | 0.0000000000E+00 | 0.0000000000E+00 | 0.0000000000E+00 |
| 2 | 5 | −1.4431099067E−15 | −1.1407499808E−15 | 5.6825058659E−20 |
| 1 | 6 | 0.0000000000E+00 | 0.0000000000E+00 | 0.0000000000E+00 |
| 0 | 7 | −3.3222565325E−15 | −1.4862003877E−15 | 5.7818036623E−19 |
| 8 | 0 | 3.2908586371E−20 | −1.1087721231E−20 | 1.4548651606E−19 |
| 7 | 1 | 0.0000000000E+00 | 0.0000000000E+00 | 0.0000000000E+00 |
| 6 | 2 | −2.0311136011E−18 | 1.4100946571E−18 | −4.0929595963E−20 |
| 5 | 3 | 0.0000000000E−00 | 0.0000000000E+00 | 0.0000000000E+00 |
| 4 | 4 | 5.8811378223E−18 | −1.4684454262E−18 | −1.2197758235E−20 |
| 3 | 5 | 0.0000000000E+00 | 0.0000000000E+00 | 0.0000000000E+00 |
| 2 | 6 | −1.1661990726E−18 | −2.0770849000E−18 | −5.1769216490E−21 |
| 1 | 7 | 0.0000000000E+00 | 0.0000000000E+00 | 0.0000000000E+00 |
| 0 | 8 | 2.3387449951E−18 | 1.6388328167E−17 | −6.4366746130E−21 |
| 9 | 0 | 0.0000000000E+00 | 0.0000000000E+00 | 0.0000000000E+00 |
| 8 | 1 | 5.5694056896E−21 | 4.0471669437E−21 | 2.2144541119E−23 |
| 7 | 2 | 0.0000000000E+00 | 0.0000000000E+00 | 0.0000000000E+00 |
| 6 | 3 | 1.3584770417E−20 | −3.1978485487E−21 | 1.4456081800E−22 |
| 5 | 4 | 0.0000000000E+00 | 0.0000000000E+00 | 0.0000000000E+00 |
| 4 | 5 | 2.5648770698E−20 | −1.2617723695E−19 | 1.2455653871E−23 |
| 3 | 6 | 0.0000000000E−00 | 0.0000000000E+00 | 0.0000000000E+00 |
| 2 | 7 | 1.1670155257E−19 | 1.2209996304E−19 | −6.9948609813E−24 |
| 1 | 8 | 0.0000000000E+00 | 0.0000000000E+00 | 0.0000000000E+00 |
| 0 | 9 | −1.4944040435E−19 | −2.4274771365E−20 | −7.3001740686E−24 |
| 10 | 0 | −4.3331500265E−24 | −9.5682078974E−25 | −1.3871955134E−24 |
| 9 | 1 | 0.0000000000E+00 | 0.0000000000E+00 | 0.0000000000E+00 |
| 8 | 2 | 4.3167096418E−23 | −1.5355197677E−23 | 5.3699663027E−25 |
| 7 | 3 | 0.0000000000E+00 | 0.0000000000E+00 | 0.0000000000E+00 |
| 6 | 4 | −1.5330294947E−22 | −3.1064642861E−23 | 2.5361779086E−25 |
| 5 | 5 | 0.0000000000E+00 | 0.0000000000E+00 | 0.0000000000E+00 |
| 4 | 6 | −3.2311797243E−22 | −7.0062263921E−22 | 5.3614470963E−26 |
| 3 | 7 | 0.0000000000E+00 | 0.0000000000E+00 | 0.0000000000E+00 |
| 2 | 8 | −3.0354253873E−22 | 6.7118141516E−22 | 8.4180607892E−26 |
| 1 | 9 | 0.0000000000E+00 | 0.0000000000E+00 | 0.0000000000E+00 |
| 0 | 10 | 1.1152824273E−21 | −6.1014558775E−22 | 8.2400402372E−26 |

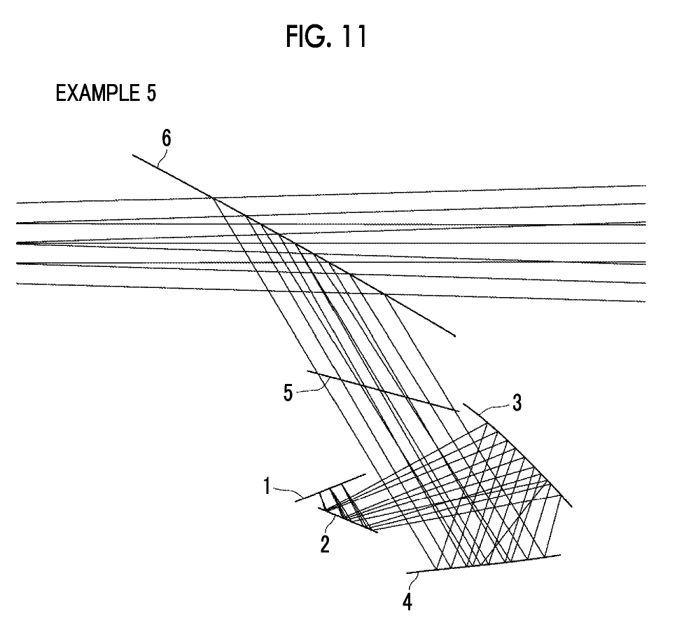

Next, a head-up display device of Example 5 will be described. FIG. 11 is a diagram showing the schematic structure of the head-up display device of Example 5. Further, Table 13 shows data regarding dimensions of the head-up display device of Example 5, Table 14 shows arrangement coordinate data of the respective elements, and Table 15 shows data regarding free-form surface coefficients of the respective mirrors.

TABLE 13
Example 5

| | |
|---|---|
| FOV[H × V] | 10° × 3.5° |
| EYE BOX SIZE [mm × mm] | 130 × 40 |
| VIRTUAL IMAGE DISTANCE [mm] | 10000 |
| IMAGE DISPLAY REGION [mm × mm] | 65 × 22.75 |

TABLE 14
Example 5

| | COORDINATE | | | NORMAL VECTOR OF | | | APERTURE DATA | | |
|---|---|---|---|---|---|---|---|---|---|
| | OF ORIGIN | | | REFERENCE PLANE | | | APERTURE | APERTURE | APERTURE Y |
| | x | y | z | i | j | k | WIDTH X | WIDTH Y | SHIFT |
| ORIGIN OF | 0.00 | 0.00 | 0.00 | 0.0000 | 0.0000 | 1.0000 | | | |
| ABSOLUTE | | | | | | | | | |
| COORDINATE | | | | | | | | | |
| IMAGE DISPLAY | 0.00 | 0.00 | 0.00 | 0.0000 | 0.1736 | 0.9848 | | | |
| PORTION | | | | | | | | | |
| OPTICAL PATH | 0.00 | −6.60 | 37.42 | 0.0000 | 0.8191 | 0.5736 | | | |
| DEFLECTING | | | | | | | | | |
| MEANS | | | | | | | | | |
| FIRST MIRROR | 0.00 | −193.71 | 70.42 | 0.0000 | 1.0000 | 0.0000 | 316 | 138 | 35 |
| SECOND MIRROR | 0.00 | −104.86 | 121.72 | 0.0000 | 0.5878 | 0.8091 | 344 | 144 | −2.5 |
| APERTURE | 0.00 | −78.14 | −68.42 | 0.0000 | 0.7313 | 0.6820 | 310 | 148 | −3.5 |
| WINDSHIELD | 0.00 | −55.87 | −226.86 | 0.0000 | 0.8829 | 0.4696 | | | |
| PUPIL | 0.00 | 778.60 | −564.00 | 0.0000 | 0.8481 | −0.5299 | | | |
| VIRTUAL IMAGE | 0.00 | −8493.24 | 3182.06 | 0.0000 | 0.8481 | −0.5299 | | | |

TABLE 15
Example 5

| PARAXIAL CURVATURE RADIUS | | FIRST MIRROR | SECOND MIRROR | WINDSHIELD |
|---|---|---|---|---|
| C(i, j) | | 806.2001 | −2246.2573 | ∞ |
| 1 | 0 | 0.0000000000E+00 | 0.0000000000E+00 | 0.0000000000E+00 |
| 0 | 1 | 2.0438472345E−01 | 1.7760783985E−01 | 9.5121514901E−03 |
| 2 | 0 | −1.9814043999E−04 | −3.4800604369E−04 | 1.1726714047E−04 |
| 1 | 1 | 0.0000000000E+00 | 0.0000000000E+00 | 0.0000000000E+00 |
| 0 | 2 | −2.4369448242E−04 | 2.2569095431E−05 | 6.6451462078E−05 |
| 3 | 0 | 0.0000000000E+00 | 0.0000000000E+00 | 0.0000000000E+00 |
| 2 | 1 | −1.8389930857E−06 | −2.6614269464E−07 | −4.0984711760E−08 |
| 1 | 2 | 0.0000000000E+00 | 0.0000000000E+00 | 0.0000000000E+00 |
| 0 | 3 | 2.6801106854E−06 | 1.6325563874E−06 | 5.8352454395E−08 |
| 4 | 0 | −3.2870221943E−09 | 4.3586592331E−10 | 1.8076488220E−10 |
| 3 | 1 | 0.0000000000E+00 | 0.0000000000E+00 | 0.0000000000E+00 |
| 2 | 2 | 2.8717815598E−08 | 1.1121078702E−08 | −8.5663602372E−11 |
| 1 | 3 | 0.0000000000E+00 | 0.0000000000E+00 | 0.0000000000E+00 |
| 0 | 4 | −2.7177271450E−09 | 5.9351285506E−09 | 5.1841972882E−11 |
| 5 | 0 | 0.0000000000E+00 | 0.0000000000E+00 | 0.0000000000E+00 |
| 4 | 1 | 1.3708912074E−10 | 3.0782425529E−11 | 1.6953219966E−13 |
| 3 | 2 | 0.0000000000E+00 | 0.0000000000E+00 | 0.0000000000E+00 |
| 2 | 3 | −1.6193249493E−10 | −1.0257995262E−10 | 9.4181254950E−14 |
| 1 | 4 | 0.0000000000E+00 | 0.0000000000E+00 | 0.0000000000E+00 |
| 0 | 5 | −1.5977878722E−10 | 5.6464918020E−11 | 4.3631225108E−14 |
| 6 | 0 | −6.5995099481E−14 | −4.6086522070E−14 | −5.7915957618E−15 |
| 5 | 1 | 0.0000000000E+00 | 0.0000000000E+00 | 0.0000000000E+00 |
| 4 | 2 | −5.1582400714E−13 | −6.3169921243E−13 | 1.2160292018E−15 |
| 3 | 3 | 0.0000000000E+00 | 0.0000000000E+00 | 0.0000000000E+00 |
| 2 | 4 | 2.9603074813E−12 | 5.8339768450E−14 | 3.9230162978E−16 |
| 1 | 5 | 0.0000000000E+00 | 0.0000000000E+00 | 0.0000000000E+00 |
| 0 | 6 | 5.9354692314E−12 | 1.5642404672E−12 | 2.0358629739E−16 |
| 7 | 0 | 0.0000000000E+00 | 0.0000000000E+00 | 0.0000000000E+00 |
| 6 | 1 | −3.5605278281E−15 | −5.3333185623E−16 | −2.9914127753E−18 |
| 5 | 2 | 0.0000000000E+00 | 0.0000000000E+00 | 0.0000000000E+00 |
| 3 | 4 | 4.6218257042E−15 | 2.3988778380E−15 | −7.1848493425E−18 |
| 4 | 3 | 0.0000000000E+00 | 0.0000000000E+00 | 0.0000000000E+00 |
| 2 | 5 | −5.3694582741E−14 | 4.7693566146E−15 | 5.6825058659E−20 |
| 1 | 6 | 0.0000000000E+00 | 0.0000000000E+00 | 0.0000000000E+00 |
| 0 | 7 | −6.0785621257E−14 | 3.0794274355E−14 | 5.7818036623E−19 |
| 8 | 0 | 1.2021900686E−17 | 1.5397122870E−18 | 1.4548651606E−19 |
| 7 | 1 | 0.0000000000E+00 | 0.0000000000E+00 | 0.0000000000E+00 |
| 6 | 2 | −2.0214742147E−17 | 2.9475730258E−17 | −4.0929595963E−20 |
| 5 | 3 | 0.0000000000E+00 | 0.0000000000E+00 | 0.0000000000E+00 |
| 4 | 4 | 1.2699151285E−17 | −6.8587899814E−18 | −1.2197758235E−20 |
| 3 | 5 | 0.0000000000E+00 | 0.0000000000E+00 | 0.0000000000E+00 |
| 2 | 6 | 2.4648542562E−16 | −6.3993924551E−17 | −5.1769216490E−21 |
| 1 | 7 | 0.0000000000E+00 | 0.0000000000E+00 | 0.0000000000E+00 |
| 0 | 8 | 1.9586766596E−16 | −1.2409711829E−16 | −6.4366746130E−21 |
| 9 | 0 | 0.0000000000E+00 | 0.0000000000E+00 | 0.0000000000E+00 |
| 8 | 1 | 5.7181102755E−20 | −6.3908813273E−21 | 2.2144541119E−23 |
| 7 | 2 | 0.0000000000E+00 | 0.0000000000E+00 | 0.0000000000E+00 |
| 6 | 3 | −6.5302616910E−21 | −8.0792854056E−21 | 1.4456081800E−22 |
| 5 | 4 | 0.0000000000E+00 | 0.0000000000E+00 | 0.0000000000E+00 |
| 4 | 5 | −3.5987097967E−20 | 1.4253082703E−19 | 1.2455653871E−23 |
| 3 | 6 | 0.0000000000E+00 | 0.0000000000E+00 | 0.0000000000E+00 |
| 2 | 7 | 2.0512576175E−18 | −2.6574575137E−18 | −6.9948609813E−24 |
| 1 | 8 | 0.0000000000E+00 | 0.0000000000E+00 | 0.0000000000E+00 |
| 0 | 9 | 1.7349566568E−18 | −2.0393394362E−18 | −7.3001740686E−24 |
| 10 | 0 | −1.9885466384E−22 | 9.4100857820E−24 | −1.3871955134E−24 |
| 9 | 1 | 0.0000000000E+00 | 0.0000000000E+00 | 0.0000000000E+00 |
| 8 | 2 | 6.7628299627E−22 | −5.4551678052E−22 | 5.3699663027E−25 |
| 7 | 3 | 0.0000000000E+00 | 0.0000000000E+00 | 0.0000000000E+00 |
| 6 | 4 | −1.8378028472E−21 | 2.2932707803E−22 | 2.5361779086E−25 |
| 5 | 5 | 0.0000000000E+00 | 0.0000000000E+00 | 0.0000000000E+00 |
| 4 | 6 | 3.8552277561E−21 | 8.4387982043E−22 | 5.3614470963E−26 |
| 3 | 7 | 0.0000000000E+00 | 0.0000000000E+00 | 0.0000000000E+00 |
| 2 | 8 | −2.1790812089E−20 | 5.0120670640E−22 | 8.4180607892E−26 |
| 1 | 9 | 0.0000000000E+00 | 0.0000000000E+00 | 0.0000000000E+00 |
| 0 | 10 | −1.0371249630E−20 | 2.3332497392E−20 | 8.2400402372E−26 |

The invention has been described above using the embodiment and the examples, but the invention is not limited to the embodiment and the examples and may have various modifications. For example, the positions and sizes of the respective elements of the head-up display device are not limited to values described in the respective examples of numerical values, and may be set to other values.

### EXPLANATION OF REFERENCES

1: image display surface
2: optical path deflecting means
3: first mirror
4: second mirror
5: aperture
6: front window (image reflective surface)
7: driver (observer)
8: virtual image plane
10, 10a, 10b, 10c: head-up display device
20: image display device
21: image display element
22: projection optical system
23: light source
24: light-scanning unit

What is claimed is:

1. A head-up display device that reflects display light of an image, which is displayed on an image display surface, toward an observer by an image reflective surface facing the observer to enlarge and display the image as a virtual image to the observer behind the image reflective surface, the head-up display device comprising:
optical path deflecting means;
a first mirror having power;
a second mirror having power; and
a light-blocking member that is provided with an aperture,
wherein display light emitted from the image display surface is reflected by the optical path deflecting means, the first mirror, and the second mirror in this order, passes through the aperture, and reaches the image reflective surface,
the image display surface and the optical path deflecting means are disposed on the same side as the observer and on a side opposite to the first mirror with respect to luminous flux that travels toward the aperture from the second mirror, and
the image display surface is disposed on a side opposite to the second mirror with respect to luminous flux that travels toward the first mirror from the optical path deflecting means.

2. The head-up display device according to claim 1,
wherein an upper end portion of the light-blocking member, which is closer to the observer than the aperture, is positioned above an upper end of the first mirror in a case in which a direction of an optical path of the display light between the second mirror and the image reflective surface is set to a vertical direction, a side corresponding to the second mirror is set to a lower side, and a side corresponding to the image reflective surface is set to an upper side.

3. The head-up display device according to claim 1, further comprising:
an image display device that includes a light source and an image display element for generating the display light carrying image information by modulating light emitted from the light source,
wherein the light source and the image display element are disposed between the optical path deflecting means and an upper end portion of the light-blocking member, which is closer to the observer than the aperture, in a vertical direction in a case in which the direction of the optical path of the display light between the second mirror and the image reflective surface is set to the vertical direction, a side corresponding to the second mirror is set to a lower side, and a side corresponding to the image reflective surface is set to an upper side.

4. The head-up display device according to claim 3,
wherein the image display device includes a projection optical system that projects an image, which is displayed on the image display element, to the image display surface as an optical intermediate image, and
the light source, the image display element, and the projection optical system are disposed between the optical path deflecting means and an upper end portion of the light-blocking member, which is closer to the observer than the aperture, in the vertical direction.

5. The head-up display device according to claim 1, further comprising:
an image display device that includes a light source and a light-scanning unit for displaying the image on the image display surface by performing scanning with light emitted from the light source,
wherein the light source and the light-scanning unit are disposed between the optical path deflecting means and an upper end portion of the light-blocking member, which is closer to the observer than the aperture, in a vertical direction in a case in which the direction of the optical path of the display light between the second mirror and the image reflective surface is set to the vertical direction, a side corresponding to the second mirror is set to a lower side, and a side corresponding to the image reflective surface is set to an upper side.
